(19) United States
(12) Patent Application Publication
(10) Pub. No.: US 2025/0157024 A1
(43) Pub. Date: May 15, 2025

(54) Method of Using a Coordinate Measuring Machine to Measure a Workpiece

(71) Applicant: Carl Zeiss Industrielle Messtechnik GmbH, Oberkochen (DE)

(72) Inventors: Nils Eckardt, Plüderhausen (DE); Reiner Schuell, Aalen (DE); Marcel Labbé-Laurent, Ellwangen (DE)

(21) Appl. No.: 18/942,867

(22) Filed: Nov. 11, 2024

(30) Foreign Application Priority Data
Nov. 10, 2023 (EP) 23209176

(51) Int. Cl. G06T 7/00; G01B 21/04

(52) U.S. Cl. CPC G06T 7/001; G01B 21/04; G06T 2207/30164

(57) ABSTRACT

A method of using a coordinate measuring machine includes accessing a database and ascertaining workpiece coordinates for a designated workpiece by evaluating corresponding measurement data or planning data. Each data record in the database includes data on at least two geometric elements that a workpiece might contain, at least one geometric relationship of the at least two geometric elements to one another, and a test feature assigned to the at least two geometric elements that is testable. The method includes creating a determination result by determining, based on the workpiece coordinates, whether the designated workpiece contains the at least two geometric elements and the at least one geometric relationship of a data record. The method includes generating a test plan for measuring the designated workpiece by, depending on the determination result in relation to the respective data record, incorporating the assigned test feature in the test plan.

### CROSS-REFERENCE TO RELATED APPLICATIONS

This application claims priority to EP 23 209 176 filed Nov. 10, 2023, the entire disclosure of which is incorporated by reference.

### FIELD

The present disclosure relates to method of using a coordinate measuring machine to measure a workpiece to be measured. A workpiece is also understood in particular to mean an arrangement of interconnected parts. In particular, the disclosure relates to the automatic creation of a measurement sequence for measuring a workpiece. Automatic creation does not preclude the possibility that parts of the measurement sequence are optionally checked and/or modified by a person.

### BACKGROUND

When measuring a workpiece, coordinates of the workpiece are ascertained using at least one coordinate measuring machine. Concrete configurations of the method according to the disclosure therefore include the process of measuring the workpiece and ascertaining the coordinates of the workpiece to be measured or of a workpiece of the same type from measurement data.

The term coordinate measuring machine includes any types of machines that can be used to ascertain coordinates of workpieces. In one class of coordinate measuring machines, the coordinates are surface coordinates, i.e. coordinates of surface points of workpieces are ascertained. Another class of coordinate measuring machines is alternatively or additionally capable of ascertaining coordinates inside workpieces. This class includes coordinate measuring machines which utilize invasive radiation that penetrates into the material of the workpiece and in particular measure the intensity of the radiation that is transmitted through the workpiece. Typically, radiation is transmitted through the workpiece from different directions and the results of the radiation transmission are taken as a basis to carry out an in particular computer-assisted reconstruction of the scanned workpiece. Such processes are also referred to as computed tomography (CT). However, the term coordinate measuring machine also includes conventional coordinate measuring machines, for example machines with a portal design or gantry design, in particular coordinate measuring machines with a movable bridge, on which in particular a quill with a sensor that can be moved relative to the bridge is mounted, articulated-arm machines and machines with a hexapod mechanism. It also includes machines of which the at least one sensor is positioned fixedly with respect to at least one degree of freedom of the relative movement of the sensor and the measurement object and in the case of which the workpiece to be measured is movable relative to the at least one sensor, e.g. in the case of a machine with a movable measurement table. The term coordinate measuring machine also covers machines which, although not primarily designed as coordinate measuring machines, are set up to work like a coordinate measuring machine. In particular, these machines have at least one measuring sensor which is used to ascertain the coordinates. For example, robots, for example articulated arm robots to which a sensor for capturing the workpiece surface (for example a structured light sensor) is fastened instead of a tool or in addition to a tool, or machine tools to which a measuring sensor (for example a tactile sensor) is fastened instead of a machining tool or in addition to a machining tool, are known. Also known for example are hexapod mechanisms, to which a sensor for capturing the workpiece surface (for example a tactile sensor) is fastened instead of a machining tool.

Person-guided (for example hand-guided) sensors for capturing a workpiece are also known, wherein the at least one sensor is optionally arranged on a movable mechanism. This case lacks a motor drive for creating the movement of the sensor. Instead, the movement is affected by a person. Both a scanning capture of the measurement object and a capture from a respective fixed position with a fixed alignment of the sensor are possible. The triangulation principle is often used for person-guided sensors: For example, a known pattern is projected onto the measurement object and at least one image of the measurement object is recorded from a different perspective on the surface. Instead of projecting a pattern, laser radiation can also be used in the application of the triangulation principle. In particular, the location of reception of the reflected laser radiation contains information about surface coordinates of the measurement object. However, machines with a person-guided sensor which have at least one motor for supporting the movement and/or positioning of the sensor are also known.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

The disclosure is also not restricted in terms of the types of sensors used by a coordinate measuring machine to ascertain the coordinates. Tactile sensors which can be, for example, those of the switching type or of the measuring type have already been mentioned as an example. The tactile sensors may in particular be passive or active sensors. Active sensors may be configured to generate a probing force with which a tactile probe probes a surface of a workpiece to be measured. Use is frequently alternatively or additionally made of optical sensors, e.g. for example a projection sensor, in particular a structured light sensor, a laser triangulation sensor, a line-scan camera, a camera for capturing two-dimensional images, a camera for capturing three-dimensional images, an arrangement with at least two cameras or a confocal, chromatic sensor. There are also, for example, capacitive sensors and inductive sensors.

The term coordinate measuring machine therefore also includes 3D scanners. As mentioned above, but not restricted to person-guided sensors, for example triangulation-based systems, such as laser scanners and projection sensors, are particularly advantageous here, since they can create many measurement points with their 3D coordinates in a short period of time. Projection sensors project a pattern, e.g. strip pattern, over a surface area onto the measurement object and capture images of the measurement object together with the projected pattern using at least one image capturing unit (camera). The 3D coordinates of surface points of the measurement object can be determined by evaluating the image recordings. In order to completely capture a measurement object or the surface of the measurement object, only one measurement position is often not enough, and therefore the relative position of the 3D scanner with respect to the measurement object is usually repeatedly changed. This positioning can take place here manually (in hand-held fashion), or else semi-automatedly or automatedly, for example by using a robot to guide the 3D scanner. The change in position can also or additionally be realized by a movement of the object relative to the 3D scanner, for example by a rotary stage.

Workpieces of the same type can be measured and tested according to the same test plan. To prepare the measurement and the evaluation of the measurement data obtained by measuring the workpiece, it is known practice to draw up a test plan, wherein test features of the workpieces to be determined from the measurement data are defined and incorporated in the test plan as part thereof. In turn, a measurement instruction can be created from the test features. The measurement instruction specifies which measurement points of a workpiece should be measured by a coordinate measuring machine in order to be able to ascertain a single test feature, a plurality of test features or all of the test features to be ascertained. The method therefore also includes configurations in which a measurement instruction is created for at least one test feature of a workpiece, the measurement instruction specifying the measurement points to be measured of the workpiece. As in the case of a measurement plan, the measurement instruction can already contain all the information necessary for the control of a measuring sensor of a specific coordinate measuring machine type or specify measurement points which can be measured by using at least one of different types of coordinate measuring machines and/or different types of measuring sensors.

In particular, a test plan defines a test process by the execution of which the quality of a workpiece to be measured can be determined. For example, such a test plan can be defined on the basis of certain general standards or manufacturer or customer specifications.

The test plan or a measurement plan derived therefrom may contain program instructions and/or an algorithm that prompt(s) a coordinate measuring machine and at least one measurement computer to execute the test process according to the test plan and in particular to ascertain the test features with respect to the measured workpiece, i.e. as a rule ascertain at least one value of the test feature in each case.

In general, the test plan and/or the measurement plan can be a file or a computer program that is readable and/or executable by a control device, wherein the control device in particular is the control device of a coordinate measuring machine and/or at least of a measurement computer, which evaluates the measurement data created by the coordinate measuring machine in order to ascertain the test features. In particular, however, the test plan can also be merely a list of test features or an extended list of test features. In the simplest case, the list can contain a single test feature. In any case, however, a test plan is a rule with regard to the measurement of a workpiece to be measured and with regard to the evaluation of the measurement data obtained during the measurement, at least by determining a test feature on the basis of the measurement data.

In common parlance, test features are quality characteristics of a process or product. In coordinate measuring technology, test features are based on the direct and indirect measurement results from the measurement of workpieces. Typically, coordinates of the respective workpiece are initially ascertained by the measurement thereof using one or more coordinate measuring machines, and then at least one value of the test feature is ascertained for at least one predefined test feature. As a rule, the coordinates of more than one measurement point or of at least one region of the workpiece are required to ascertain the test feature. Examples of test features include straightness, flatness, roundness, cylindricity, profile of a line, profile of a surface, position, perpendicularity, inclination, parallelism, symmetry, coaxiality, concentricity, true (radial) runout, true (axial) runout, total true (radial) runout and total true (axial) runout. A person skilled in the art is familiar with numerous other test features, such as e.g. gap and transition dimensions. A permissible tolerance is generally defined in order to be able to test at a later stage whether a workpiece according to the respective test feature meets expectations. Even if test plans are used repeatedly, the amount of tolerance allowed may vary in the individual cases. In addition, the methods for ascertaining a test feature by evaluating coordinate measurement data of a workpiece can vary. Optionally, definitions for the method can therefore also be provided as additional information for the respective test feature. The foregoing also applies in particular to configurations of the disclosure described below.

The selection and/or definition of the test features for a test plan involves work, especially if a complete or nearly complete list of test features should be drawn up with regard to a specific workpiece type and the verification of the technical specification thereof. In general, and also with respect to the present disclosure, the technical specification may be available, for example, as a CAD (Computer Aided Design) model with PMI (Product Manufacturing Information). In many cases, however, the complete list of test features cannot be derived from such a technical specification. Rather, additional experience and knowledge is required to complete the list.

WO 2016/150517 A1 has already suggested to support an operator in this case. Provision is made for a database that contains a multiplicity of predefined measurement elements and a multiplicity of typical test features for the predefined measurement elements. Each typical test feature represents a defined dimensional property of at least one predefined measurement element. Moreover, a pictorial representation of the measurement object is provided, the pictorial representation showing at least one first geometric element. The operator can select the first geometric element on the basis of the pictorial representation. Suitable test features for the selected first geometric element are subsequently displayed to the operator. In this case, the suitable test features are determined from the multiplicity of typical test features in the database by the selected first geometric element being assigned to a predefined measurement element of the same type. The operator can select a displayed suitable test feature. A defined measurement sequence is created depending on the selected test feature. In a specific configuration, the operator is offered suitable linkage elements for automatically creating a defined measurement sequence as soon as at least two geometric elements have been selected in the pictorial representation of the measurement object. Preferably, the display of suitable test features and the display of suitable linkage elements is implemented simultaneously such that the operator comes to a complex measurement sequence by selecting test features and linkage elements in a representation.

It is an object of the present disclosure to facilitate the ascertainment of at least one test feature for incorporation in a test plan.

It is proposed that data records are stored in advance in a database, the data records containing data about at least two geometric elements of a workpiece and about at least one geometric relationship of the at least two geometric elements in relation to one another.

According to the disclosure, the geometric relationship is a dimensional relationship, i.e. a relationship defined with respect to a dimension or a plurality of dimensions of a system of sizes. Examples of dimensions are lengths (for example, distances, measurements, diameters), areas (e.g. of surface regions), volumes (e.g. partial volumes of workpieces), angles (e.g. angles enclosed by two edges or two planes or angles as a measure of the size of circular segments), and radii of curvature (for example of edges). It is possible to specify a value for the dimension or for each of the individual dimensions as a matter of principle. Therefore, in the presence of a real workpiece, or else if sufficient planning data (for example CAD data used as the basis for the production) of a workpiece or a workpiece type are available, a value of the respective dimension can be ascertained, in particular by using at least one coordinate measuring machine which ascertains the coordinates of measurement points of the workpiece or by evaluating the planning data. An example of this case is a distance between two geometric elements, for example two parallel edges or the lines representing these parallel edges. The dimensional relationship of these parallel lines might define that the distance must have a specific value. However, the dimensional relationship need not always relate to the values of dimensions that need to be ascertained in order to determine the presence of the geometric elements of the data record. In other cases, for example, the dimensional relationship can instead define the ratio (for example, as a quotient or otherwise) of a dimension of the one geometric element to a dimension of the other geometric element. A simple example is the ratio of the lengths of the one geometric element and the other geometric element. With regard to the example of the parallel lines, the ratio of the distance between the two lines to the length of at least one of the two lines can also be defined as dimensional relationship. At this point, however, it should be emphasized that a data record can also contain data about more than two geometric elements (i.e. the geometric elements are defined at least in such a way that they are ascertainable from measurement data of the workpiece to be measured or from the planning data for the workpiece). Therefore, the data record may also contain a dimensional relationship or a plurality of dimensional relationships that relate to more than two geometric elements.

In addition, the data record contains at least one test feature assigned to the at least two geometric elements, the test feature being testable with respect to the at least two geometric elements for the workpiece. The data record contains more than one assigned test feature in many cases, even if there are only two geometric elements for which the data record contains data.

Such a data record allows determination of whether the workpiece to be measured contains the at least two geometric elements and the at least one geometric relationship of the data record. Should this be determined, the assigned test feature or at least one of the assigned test features can be automatically incorporated in a test plan for testing the workpiece.

On the basis of geometrically dimensional criteria, the disclosure thus enables an objective and automatic ascertainment as to whether or not test features predefined with respect to the geometry of basically any desired workpiece are incorporated in the test plan of a workpiece to be measured. If the geometry of the workpiece to be measured corresponds to the geometry defined in the respective data record, then the test feature or at least one of the assigned test features (and all test features assigned by the data record) is incorporated in the test plan. Hence, the results of the earlier creation of test feature lists of similar workpieces can be automatically used for the test plan of the workpiece to be measured. In particular, this also relates to the combination of a plurality of test features. If such a combination has already been defined for a similar workpiece and at least a corresponding data record has been created, then such a combination of test features can also be incorporated in the test plan in the event of sufficient correspondence or similarity of the workpiece to be measured.

The identification of a test feature or a combination of test features from data records stored in a database also allows identification of additional information concerning the implementation of the measurement of the workpiece provided this additional information is also stored in the database or a reference to this additional information is stored in the database. In particular, the data record may therefore contain such additional information and/or a reference thereto. The reference is configured to allow access to the additional information. In particular, this additional information can therefore be incorporated in the test plan and/or a corresponding measurement plan for measuring the workpiece to be measured or for measuring a workpiece of the same type. The recording may take place depending on the determination result mentioned hereinbelow.

This additional information may also include, in particular, such information that relates to the ascertainment of the test feature, for example to the specification of the evaluation method (e.g. evaluation by way of Gauss element or with a modifier, e.g. with a projected tolerance zone), and/or that relates to auxiliary constructs indirectly required for the test feature (e.g. line of symmetry, point of intersection, etc.).

In particular, the following is proposed: A method of using a coordinate measuring machine to measure a workpiece to be measured, wherein
a database is accessed in which a plurality of data records are stored, each containing data on:
a) at least two geometric elements which a workpiece might contain,
b) at least one geometric relationship of the at least two geometric elements in relation to one another, the geometric relationship being a dimensional relationship thus allowing determination as to whether the geometric relationship exists in a workpiece to be measured, by way of ascertaining and evaluating coordinates of the at least two geometric elements,
c) at least one test feature assigned to the at least two geometric elements, the at least one test feature being testable with respect to the at least two geometric elements for a workpiece to be tested,
workpiece coordinates are ascertained for a workpiece to be measured, by evaluating measurement data of the workpiece to be measured and/or planning data of the workpiece to be measured,
the workpiece coordinates are used to determine whether the workpiece to be measured contains the at least two geometric elements and the at least one geometric relationship of at least one of the plurality of data records, and a corresponding determination result is created, and
depending on the determination result in relation to the respective data record, the at least one assigned test feature or at least one of the assigned test features is incorporated in a test plan for measuring the workpiece to be measured or for measuring a workpiece of the same type or is confirmed as part of the test plan.

The type of geometric relationship has already been discussed above. It is a dimensional geometric relationship, which thus allows determination as to whether the geometric relationship exists in a workpiece to be measured, by ascertaining and evaluating coordinates of the at least two geometric elements. However, the ascertainability of whether the geometric relationship exists is not a sufficient condition for this to be a dimensional condition. For example, a non-dimensional geometric relationship between two parallel lines, each representing an edge of a workpiece, may consist in their parallelism. Many types of workpieces meet this condition. There only need to be two parallel edges. However, if the geometric relationship additionally defines that the distance between the parallel lines must have a defined value (i.e. a value of dimension length or distance) and/or additionally defines that the length of the distance is in a defined relationship with another dimension of at least one of the geometric elements, then this is a dimensional geometric relationship and allows more targeted ascertainment of groups of geometric elements. The test features, which correspond to these groups ascertained in a targeted manner and which were already useful in the past when testing workpieces, can therefore be ascertained in a more targeted manner with regard to the workpiece to be measured than when the dimensionality of the relationship is not taken into account.

As above, the data record relates to a workpiece to be measured. Especially when a plurality of workpieces of the same type are produced, like in series production, the data record can also relate to a workpiece of the same type. In this case, it can also be said that the data record also relates to the workpiece to be measured. Furthermore, the workpiece coordinates for the determination as to whether the workpiece to be measured contains the at least two geometric elements and the at least one geometric relationship of at least one of the plurality of data records can be obtained from a workpiece of the same type, and it can nevertheless still be correctly said that the workpiece coordinates are also valid for the workpiece to be measured. In other words, the workpiece to be measured can be a specific instance or any instance of a type. Within the scope of this determination, it is irrelevant in most cases whether there are minor deviations between the workpieces of the same type and/or between one of the workpieces of the same type and planning data. For this reason, it is preferable for a tolerance to be allowed when determining whether the workpiece to be measured contains the at least two geometric elements and the at least one geometric relationship from at least one of the plurality of data records. This means that, in particular, the workpiece to be measured is also determined as containing the at least two geometric elements and the at least one geometric relationship of the data record in the event of the specified maximum tolerance not being exceeded. Then, tolerance can relate to all specifications of dimensions and positions, and to information used to ascertain the geometric elements and the geometric relationship. Conversely, however, the tolerance in individual cases need not apply to all of these specifications and pieces of information. Rather, a tolerance may also be permitted only for one of the specifications and/or for one of the pieces of information used to ascertain the geometric elements and the geometric relationship. A tolerance takes into account various circumstances, such as the fact that workpiece coordinates cannot be measured exactly and, values (measured values and planning data) cannot be processed by computers without processing errors (e.g. rounding errors). The ascertainment of similar data records can also be rendered possible by a tolerance with respect to the geometric relationship of the geometric elements. A corresponding example is yet to be described below on the basis of the enclosed figures.

The determination result can be described as positive in particular if it means that the workpiece to be measured contains the at least two geometric elements and the at least one geometric relationship (overall, this can also be described as the workpiece to be measured corresponding to the data record) or is likely to contain these according to a predetermined assessment method. In the event of a positive determination result, the at least one assigned test feature or at least one of the assigned test features can be incorporated in the test plan of the workpiece to be measured or be confirmed as part of the test plan. The procedure whereby an assessment is made during the determination and the probability of correspondence between the workpiece to be measured and the data record is ascertained represents a variant of the aforementioned tolerance for deviations. In particular, the probability can be ascertained by using statistical methods to ascertain, for a number of measurement points or points of the workpiece to be measured obtained from the planning data, in particular for a defined number of such points, the deviation of the at least two geometric elements defined in the data record taking into account the at least one geometric relationship. For example, the square root of the sum of the squared deviations of the points can be formed as measure of the probability in this case. It is preferable that the measure of probability is normalized. A limit probability can be specified for the normalized measure. The determination result is positive should the probability obtained specifically for a workpiece to be measured be higher than the limit probability.

According to the disclosure, at least two geometric elements which are in a dimensionally defined relationship to one another are defined by each of the data records. When ascertaining whether the geometric elements defined in a specific data record are present for a workpiece to be measured, the geometric elements defined in the data record can be examined individually as to whether or not they are present for the workpiece to be measured. Use of the data record for creating/checking a test plan is discarded should only one of the geometric elements be determined as present in the workpiece to be measured or should, in the case of more than two geometric elements defined in the data record, not all of these geometric elements be present in the workpiece to be measured. By contrast, should all geometric elements defined in the data record be present for the workpiece to be measured, it is possible to ascertain whether or not the dimensional geometric relationship defined in the data record also exists in the geometric elements present.

More generally, therefore, when determining whether the workpiece to be measured contains the at least two geometric elements and the at least one geometric relationship of at least one of the plurality of data records, a configuration of the method can include an initial determination with respect to one of the data records as to whether the workpiece to be measured contains all the geometric elements for which the geometric relationship of the geometric elements is defined in relation to one another in the data record and, if so, there is a subsequent determination as to whether the geometric relationship exists for the geometric elements of the workpiece to be measured.

In particular, a plurality of the data records stored in the database can be ascertained with respect to the same geometric elements of the workpiece to be measured, the data records each defining data record geometric elements that correspond to the same plurality of geometric elements of the workpiece to be measured and also each defining a geometric relationship of these data record geometric elements. However, it is frequently the case that the correspondence of, firstly, the geometric elements of the data record and, secondly, the workpiece to be measured is not exact and/or that the geometric relationship defined in the respective data record does not exist exactly for the geometric elements of the workpiece to be measured. It is therefore proposed that a measure of correspondence of the geometric elements and the geometric relationship is ascertained for each of the ascertained data records. This enables labelling of ascertained data records as non-corresponding or having a lower correspondence than at least one other ascertained data record, and optionally of an exclusion of the data records from the set of ascertained data records. In particular, the data record with the highest measure of correspondence can be selected and the at least one assigned test feature or at least one of the assigned test features of this selected data record can be incorporated in the test plan for measuring the workpiece to be measured or for measuring a workpiece of the same type or can be confirmed as part of the test plan.

More generally, there can be an ascertainment of a plurality of the data records stored in the database, which each define data record geometric elements corresponding to the same plurality of geometric elements of the workpiece to be measured and which also each define the geometric relationship for these data record geometric elements, wherein a measure for a correspondence of the geometric elements and the geometric relationship is ascertained for each of the plurality of ascertained data records and wherein the measure of correspondence is used to ascertain at least one of the plurality of ascertained data records as non-corresponding or having a lower correspondence than at least one other data record of the plurality of determined data records. For example, the measure can be a measure of the aforementioned probability of a correspondence of the workpiece to be measured and the data record.

The respective assigned test feature can be tested, as described above, with respect to the at least two geometric elements for a workpiece to be tested. When the test feature is ascertained, at least one test feature value arises if the data pool is sufficient for this purpose. By preference, at least one test feature which depends on the at least two geometric elements and/or their relationship to one another is contained in the data record. Such a test feature is therefore not a test feature that is already ascertainable by evaluating the coordinates of only one of the geometric elements. However, it is not precluded and advantageous in many cases for the data record in any case to also contain at least one test feature which is already ascertainable by evaluating the coordinates of one of the geometric elements. For example, in the case of two parallel edges as the two geometric elements, each of the geometric elements can be assigned the test feature of straightness. Moreover, the data record for example also contains the test feature of parallel edge parallelism as a test feature, the ascertainability of which depends on the relationship of the geometric elements to one another, i.e. depends on the availability of the coordinates of both geometric elements.

As mentioned above, the method can be used not only to adopt at least one test feature from the data record in a test plan in the event of correspondence between the workpiece to be measured and the data record, but also to confirm a test feature present in a test plan or for confirmation that a test feature that is in question for incorporation in the test plan is actually incorporated. For example, the test features of a test plan available for a type-similar workpiece can therefore be tested in this way and optionally confirmed. If a test feature is not confirmed, it can be removed from the test plan.

The disclosure relates in particular to the automated ascertainment of the workpiece coordinates, the automated implementation of the determination as to whether the workpiece to be measured contains the at least two geometric elements and at least a geometric relationship of at least one of the plurality of data records, and the automated incorporation and/or confirmation of at least one test feature of at least one of the plurality of data records in/for the test plan. Should measurement data of the workpiece to be measured be evaluated in the event of the ascertainment of the workpiece coordinates, the measurement of the workpiece can also be a step in the method. In any case, the evaluation of the measurement data with regard to the ascertainment of the workpiece coordinates consists at least in ascertaining the workpiece coordinates required for the determination to be carried out. This can be restricted to a selection of measurement points and/or include further evaluation steps, such as ascertaining the coordinates for a selection of measurement points or for all measurement points from the raw measurement data of a coordinate measuring machine.

More generally, therefore, the workpiece to be measured can be measured by using at least one coordinate measuring machine, and the measurement data can be created to ascertain the workpiece coordinates.

Further, in an alternative to that or in addition, as part of the method, the workpiece to be measured or a workpiece of the same type can be measured by using at least one coordinate measuring machine according to the test plan, and/or a value of the test feature incorporated in the test plan or confirmed as part of the test plan can be ascertained.

As mentioned, the aforementioned workpiece coordinates are used to determine whether the workpiece to be measured contains the at least two geometric elements and the at least one geometric relationship from at least one of the plurality of data records. Depending on the type of geometric element and/or depending on the procedure, the presence of the geometric element (or else the non-presence) can be determined in particular on the basis of its geometric position (for example, position in a coordinate system of the workpiece), alignment (for example, alignment in a coordinate system of the workpiece), type (for example, plane, edge, drilled hole), shape (for example, straight line, curved, angled, circular, elliptical), size (characterized by at least one dimension) and/or relationship to other geometric elements of the workpiece (for example, edge parallel to another edge, drilled hole as part of an arrangement with a plurality of drilled holes, flat surface region extending at an angle with respect to another flat surface region) by evaluating the workpiece coordinates.

In the case of evaluating planning data of the workpiece to be measured in workpiece coordinates in order to determine whether the workpiece to be measured contains the respective geometric element, the workpiece coordinates can also be the coordinates of points like in the measurement of a workpiece, i.e. they correspond to measurement points during measurement. In the case of planning data, however, it is also possible, depending on the data format of the planning data, that other geometric information is evaluated apart from at least individual coordinates. For example, planning data are known in formats that use vectors and thus directions and/or lengths of geometric elements to describe the geometry of the workpiece to be measured. Depending on the type of geometric element to be determined, such lengths and/or directions can therefore be evaluated, for example compared with corresponding lengths and/or directions of the geometric element to be determined, optionally taking into account the position in the coordinate system of the workpiece or another coordinate system. In addition, formats are known which describe in particular the surfaces of workpieces by using networks. For example, the triangulated irregular network (TIN) is widely used. Information about the TIN can be stored as the triangular areas and/or as the nodes at the corners of the triangular areas.

The database can be created once. Alternatively, the database can be repeatedly supplemented with additional data records, which are formed from existing test plans, for example. This increases the probability that at least one suitable data record is available when creating a test plan for a workpiece.

The data records in the database can be stored in the same data format as the information, based on the workpiece coordinates, about the workpiece to be measured or in a different format. In the step of determining whether the workpiece to be measured contains a geometric element defined by the respective data record, it may therefore be necessary to at least partially convert the one data format into the other data format or to convert both data formats in such a way that comparable data are obtained. In principle, however, exactly the same data formats need not be achieved, and the data available in the various data formats need not be completely converted into a common data format. Rather, whether and to what extent at least one of the data formats must be changed depends on the type of geometric element and the determination procedure. For example, a straight line which has known length and known position in the workpiece coordinate system and corresponds to an edge of the workpiece can be easily compared with a multiplicity of points defined by the workpiece coordinates to be evaluated. For example, a plurality of points can be used to create a straight line by curve fitting, and a test can then be carried out as to whether the straight line corresponds in terms of length and position to the line defined in the data record or to what extent it corresponds. The extent to which the two lines may deviate from each other such that the determination is still considered positive, i.e. the geometric element is present in the measured workpiece, can be defined in the data record or in another way. For example, a maximum deviation of the direction of the lines and also a maximum deviation of the length of the lines might be defined with respect to the straight line. In order to avoid misunderstandings, it should be observed here that the workpiece coordinates need not necessarily be specified in the workpiece coordinate system, even if this is possible.

If a plurality of the data records are stored in the database, it is in particular also possible from the workpiece coordinates to ascertain which geometric elements from different data records correspond to geometric elements of the workpiece to be measured. For example, this can be ascertained in each case for a type of geometric element, for instance in each case for an edge or line, for a surface region or plane surface, or a circular drilled hole or circular line, etc. For each geometric element of the workpiece to be measured, which might be relevant to a test of the workpiece in principle, corresponding geometric elements can be searched for in the stored data records in the process, or, vice versa, whether the workpiece to be measured contains this geometric element can be ascertained for geometric elements of the data records.

The method can be an at least partly computer-implemented method in particular. In particular, the aforementioned automatic steps of ascertaining the workpiece coordinates, implementing the determination and incorporating and/or confirming at least one test feature of at least one of the plurality of data records in/for the test plan are computer-implemented. In addition, the steps of measuring the workpiece to be measured or a workpiece of the same type, as mentioned in this description, can be computer-implemented. However, the respective measurement is carried out in any case using at least one or by at least one coordinate measuring machine. This includes automatically operated coordinate measuring machines, but also coordinate measuring machines with handheld sensors.

The scope of the disclosure therefore also includes a computer program comprising commands that, upon execution of the program by a computer or by an arrangement of computers, prompt the computer or arrangement of computers to carry out the method in one of the ways or configurations described in this description. The disclosure also comprises a computer-readable storage medium comprising commands that, upon execution by a computer or by an arrangement of computers, prompt the computer or arrangement of computers to carry out the method in one of the ways or configurations described in this description.

Therefore, in particular, the apparatus described below for carrying out the method may comprise a computer program which carries out the associated process steps when the computer program is executed on a computer or an arrangement of computers.

Those parts of the apparatus which carry out computer-implemented process steps as mentioned above may, for example, consist of a single computer or a computer network or comprise the computer or computer network. The computer or at least one of the computers may be, with respect to its method of operation, in particular an analogue computer, a digital computer and/or a hybrid computer. In terms of size and design, it may be a smartphone, a personal digital assistant (PDA), a tablet computer, an embedded system (e.g. embedded in the control computer of a coordinate measuring machine), a single-board or multi-board computer, a personal computer (PC), a desktop computer, a workstation computer, a host computer or server integrated into a computer network, a thin client computer, a netbook, a notebook, a laptop, a mainframe computer, or a supercomputer, wherein some of the types can also be implemented by means of a single computer, such as a multi-board PC. Furthermore, the computer or at least one of the computers may have one or more central processing units (CPU) and/or one or more computing cores per CPU. Graphics cards or other dedicated cards with processing units that are part of a computer may also be the means for carrying out the method, either exclusively or in combination with other computers or processing units.

Moreover, the scope of the disclosure includes a computer program comprising commands that, upon execution of the program by a computer or by an arrangement of computers, prompt the computer or the arrangement of computers to execute the computer-implemented parts of the method, in particular execute the method in one of the configurations described.

Furthermore, attention should be drawn to the fact that although the computer or computers is/are prompted by a computer program to execute the method, the means for executing the method may also at least comprise a hardware-realized, programmable arrangement (for example an arrangement of logic gates), for example an ASIC (application-specific integrated circuit), a PLD (programmable logic device) or an FPGA (field programmable gate array).

Furthermore, the scope of the disclosure includes an arrangement having the apparatus, wherein the arrangement further comprises at least one coordinate measuring machine configured to carry out the measurement of the workpiece or workpieces and create corresponding measurement data. For example, the measurement data can be raw measurement data or already data about coordinates of measurement points. It is also possible that the coordinate measuring machine creates and outputs the workpiece coordinates required for the above-described determination. Furthermore, the created measurement data can be created by measuring the workpiece to be measured or a workpiece of the same type in accordance with the test plan in order to ascertain, from the created measurement data, a value of the test feature incorporated in the test plan or confirmed as part of the test plan.

In an alternative to that or in addition, the database having the plurality of data records can be part of the arrangement.

As mentioned above, the disclosure relates to an apparatus for carrying out the method in one of the ways and configurations described in this description, wherein the apparatus in particular comprises:
an access device configured to access a database in which a plurality of data records are stored, each containing data on:
a) at least two geometric elements which a workpiece might contain,
b) at least one geometric relationship of the at least two geometric elements in relation to one another, the geometric relationship being a dimensional relationship thus allowing determination as to whether the geometric relationship exists in a workpiece to be measured, by way of ascertaining and evaluating coordinates of the at least two geometric elements,
c) at least one test feature assigned to the at least two geometric elements, the at least one test feature being testable with respect to the at least two geometric elements for a workpiece to be tested,
an evaluation device configured to ascertain workpiece coordinates for a workpiece to be measured, by evaluating measurement data of the workpiece to be measured and/or planning data of the workpiece to be measured,
a determination device configured to use the workpiece coordinates to determine whether the workpiece to be measured contains the at least two geometric elements and the at least one geometric relationship of at least one of the plurality of data records, and to create a corresponding determination result, and
a test plan device configured, depending on the determination result in relation to the respective data record, to incorporate the at least one assigned test feature or at least one of the assigned test features in a test plan for measuring the workpiece to be measured or for measuring a workpiece of the same type or to confirm this as part of the test plan.

Configurations and developments of the apparatus and an arrangement having the apparatus emerge from configurations and developments of the method, and vice versa. For example, the apparatus, as mentioned, can be part of an arrangement which comprises at least one coordinate measuring machine, and the coordinate measuring machine or at least one of the coordinate measuring machines can be configured or used to measure the workpiece to be measured and create the measurement data in order for the evaluation device, which evaluates measurement data, to ascertain the workpiece coordinates.

As already mentioned, tolerances should be taken into account with regard to the measurement and production of workpieces. When defining the respective tolerance, a compromise must be found between the striving for a workpiece manufactured without tolerances where possible on the one hand and the feasibility and effort on the other. For this reason, the planning data for the manufacture of workpieces often define permissible tolerances. A permissible tolerance with respect to the assigned test feature can therefore already be defined in the existing data records which are stored in the database. However, it is also possible to define the permissible tolerance at a later stage or determine it from the planning data for the manufacture of the workpiece.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 shows a coordinate measuring machine, which only in the present example embodiment is a conventional coordinate measuring machine of portal design,

FIG. 2 schematically shows a computer comprising various devices for carrying out the method according to the disclosure,

FIG. 3 shows a spanner with a jaw and a ring, each for contacting the head of a hexagon screw or a corresponding nut,

FIG. 4 shows geometric elements that characterize the spanner shown in FIG. 3,

FIG. 5 shows a spanner with a jaw on each of the opposite ends of the grip area, with the geometric elements from FIG. 4 and, defined for these geometric elements, the geometric relationships to which the spanner corresponds being ascertained for the spanner,

FIG. 6 shows a flowchart schematically showing a method for identifying an existing data record on the basis of geometric elements and a geometric relationship of the geometric elements,

FIG. 7 shows an arrangement of geometric elements defined in an existing data record, and

FIG. 8 shows an arrangement of geometric elements of a workpiece to be measured.

In the drawings, reference numbers may be reused to identify similar and/or identical elements.

### DETAILED DESCRIPTION

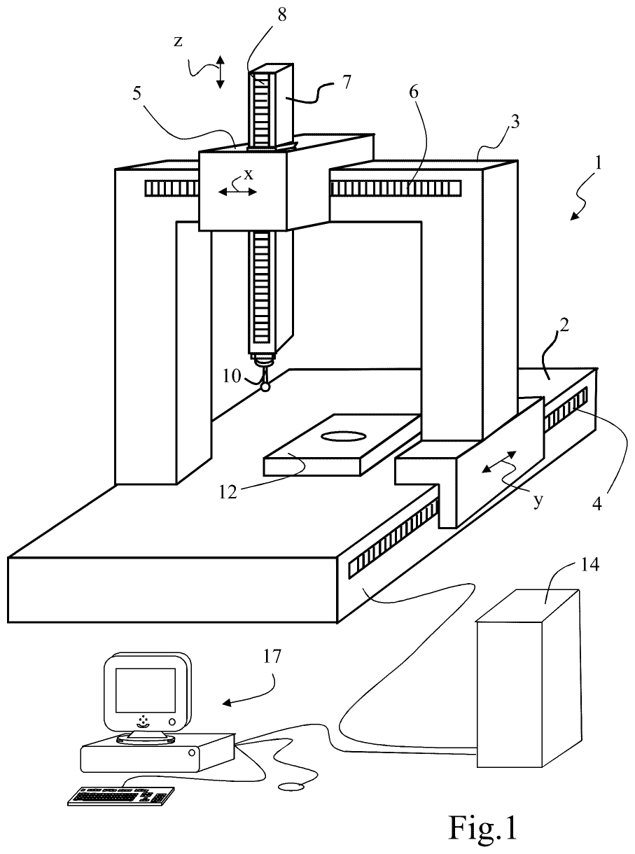

FIG. 1 schematically shows a coordinate measuring machine 1 of portal design. A first carriage 3 in the form of a portal is movably guided along two parallel guides in the region of a measurement table 2 (e.g. a granite slab). A first scale 4 is provided for measuring the position of the portal according to a first linear movement axis y. The position is read using an appropriate reading sensor (not depicted here); this is also true for further scales described below. Moreover, provision is made for a first drive (not depicted here) which can drive a movement of the first carriage 3 in the y-direction.

A second carriage 5 is movably guided along the crossbeam of the portal-shaped first carriage 3 that spans the measurement table 2 horizontally, wherein a second scale 6 and a corresponding second reading sensor (not shown) are provided for measuring the position of the second carriage relative to the portal in accordance with a second linear movement axis x. A movement of the second carriage 5 in the x-direction can be driven by a second drive (not shown).

A third carriage, specifically a quill 7, is movably guided in turn on the second carriage 5, wherein a third scale 8 and a corresponding third reading sensor (not shown) are provided for measuring the position of the quill relative to the second carriage 5 in accordance with a third linear movement axis z. A movement of the quill 7 in the z-direction can be driven by a third drive. A measuring sensor 10 is arranged below the lower end of the quill 7 and in the present case is embodied in the form of a stylus with a probe ball (i.e. as a tactile sensor), the stylus being e.g. fastened to the lower end of the quill 7 by way of a measuring head and an interchange interface.

A workpiece 12 is arranged on the measurement table 2 and can be probed by the measuring sensor 10 by moving the three carriages 3, 5, 7, wherein measured values on the surface of the workpiece 12 to be measured are ascertained from the signals of the measuring sensor 10 and/or the measuring head and also from the scale positions of the scales 4, 6, 8. A controller implemented by a computer program executed on a control computer 14 provides open-loop and/or closed-loop control for the drives of the carriages 3, 5, 7. A measurement computer 17 can be connected to the controller and serves to receive and process the read scale values from the scales 4, 6, 8 and the signals from the measuring sensor 10 and/or the measuring head in order to create the coordinates of the measurement points on the surface of the workpiece 12 measured by the measuring sensor 10.

Especially the measurement computer 17 shown in FIG. 1, or another measurement computer or an arrangement of measurement computers, can comprise the access device for accessing the database, the evaluation device for ascertaining the workpiece coordinates, the determination device for determining whether the workpiece to be measured corresponds to at least one of the plurality of data records, and the test plan device for incorporating the at least one test feature from the data record in the test plan or for confirming at least one test feature as part of the test plan. Alternatively, the measurement computer or the arrangement of measurement computers can comprise at least some of these devices, especially the evaluation device for ascertaining the workpiece coordinates. By contrast, the access device, the determination device and the test plan device, in particular, can be realized together on at least one other computer or on at least one other arrangement of computers.

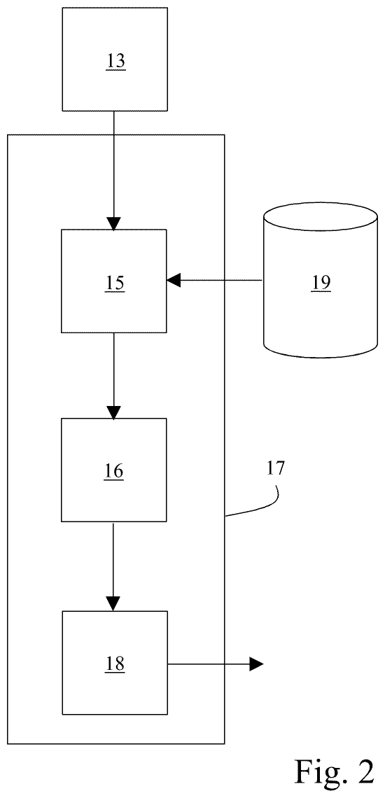

FIG. 2 schematically shows a computer, the computer 17 shown in FIG. 1 in the example embodiment. The computer comprises the access device denoted by reference sign 15, the determination device denoted by reference sign 16 and the test plan device denoted by reference sign 18. The evaluation device 13 is shown at the top of FIG. 2 as a device realized outside the computer. As indicated by an arrow pointing from top to bottom to the access device 15, the access device 15, when in operation, receives the workpiece coordinates from the evaluation device 13. Furthermore, the access device 15 receives the data of the data records from the database 19 or accesses these data records. Alternatively, the determination device 16 can receive the workpiece coordinates directly from the evaluation device 13 and also receive the data of the data records from the access device 15 connected to the determination device 16 in any case. The determination result or the determination results are transmitted from the determination device 16 to the test plan device 18 connected thereto. This incorporates the at least one assigned test feature or at least one of the assigned test features, depending on the determination result in relation to the respective data record, in a test plan for measuring the workpiece to be measured or for measuring a workpiece of the same type or confirms this as part of the test plan. The arrow pointing to the right from the test plan device 18 at the bottom of FIG. 2 indicates that corresponding information or corresponding data can be output from the test plan device 18. For example, this could be the test plan. If a plurality of the data records from the database 19 were determined as corresponding to the workpiece to be measured, a plurality of test features are also incorporated in the test plan and/or confirmed as part of the test plan.

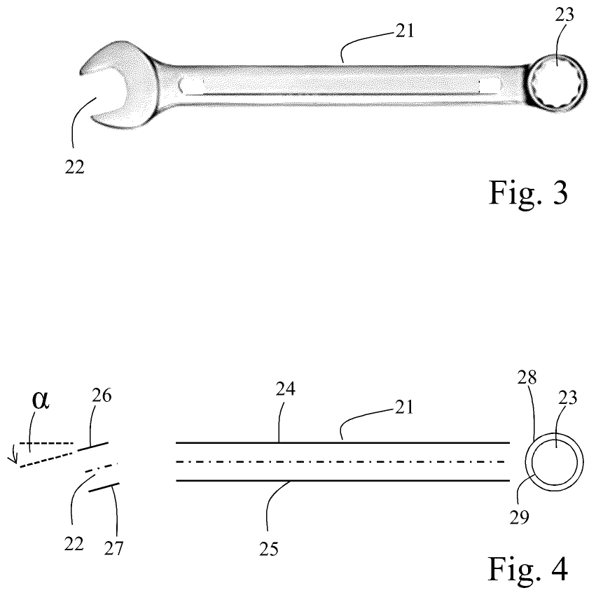

Example embodiments of data records and corresponding workpieces are described below. FIG. 3 shows a spanner 21, which has a jaw 22 on its left end and a ring 23 on its right end. Both the jaw 22 and the ring 23 are suitable for contacting the head of a hexagon screw with a size corresponding to the inner dimensions of the jaw 22 or ring 23, and so the screw can be turned in the desired direction of rotation. The long edges of the grip area of the spanner 21 are parallel to each other, as is conventional.

FIG. 4 shows geometric elements that correspond to the long edges of the grip area, the jaw 22 and the ring 23. In this case, parallel straight lines 24, 25 of equal length correspond to the long edges of the grip area, two short and parallel straight lines 26, 27 of equal length correspond to the inner edges of the jaw 22 and two concentric circular lines 28, 29 correspond to the ring 23. The dash-dotted line of symmetry is shown for the straight lines 24, 25. The dash-dotted line of symmetry is also shown for the short straight lines 26, 27 of the inner edges of the jaw 22. The inner circle 28 of the mutually concentric circular lines 28, 29 represents a compensation circular line for the inner surface of the ring 23. For example, the inner circle 28 touches each of the segments that form the inner surface of the ring 23, contact being at the point of the segment closest to the common center of the circular lines 28, 29. The outer circle 29 of the mutually concentric circular lines 28, 29 corresponds to the outer edge of the ring 23.

From these geometric elements (the long straight lines 24, 25, the short straight lines 26, 27 and the concentric circular lines 28, 29), the following data records in particular can be formed, wherein a plurality of the data records described below can optionally also be combined in a data record:

The first data record concerns the jaw 22 and contains the data of the geometric elements that each define one of the short straight lines 26, 27. The data record also defines that the two straight lines run parallel to each other. However, this still leaves open the distance between the short straight lines 26, 27 and, in particular, the ratio of their length to their spacing. The definition of the length of the distance or of the aforementioned ratio is needed to geometrically characterize the jaw 22. Therefore, the following geometric relationships are defined as part of the first data record in the example embodiment specifically described here: The length of the short straight lines 26, 27 is x, where x is a value of a defined dimension. This value of the defined dimension either can be specified in the data record or can be left open if, e.g. after multiplication by a scaling factor, mutually congruent jaws of different spanner sizes should be defined by the data record. In addition, the distance being equal to the length of the short straight lines 26, 27 multiplied by a factor that is 1.3 in the example embodiment is defined as a geometric relationship, and so the distance A is equal to the length x multiplied by 1.3, or A=1.3*x. This geometric relationship is a dimensional geometric relationship between the two geometric elements (the short parallel straight lines 26, 27).

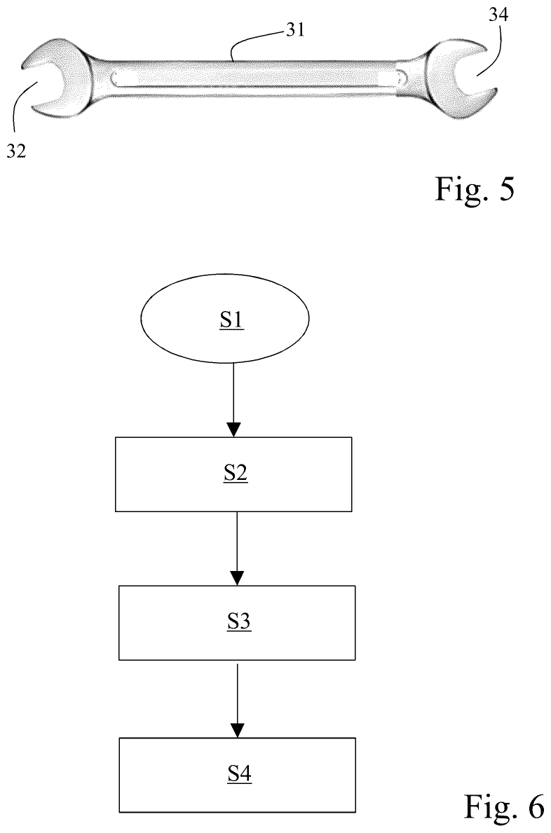

The second data record relates to the alignment of the jaw 22, which is angled relative to the longitudinal direction of the spanner (for example, defined by the direction of the course of the long straight lines 24, 25). In FIG. 5, this angled configuration of the jaw 22 is recognizable by an inclination relative to the horizontal of FIG. 5 with an inclination angle α of 15 degrees. In FIG. 5, extensions of the upper long straight line 24 and the upper short straight line 26 are depicted in the left of the figure as dashed lines. These extensions include the inclination angle α. The second data record therefore contains the data of at least one of the long straight lines 24, 25 and one of the short straight lines 26, 27 as data of the geometric elements. Furthermore, as regards the geometric relationship in the second data record of at least these lines 24 or 25 on the one hand and 26 or 27 on the other hand to each other, it states that they include an angle of 15 degrees to each other. In this case, the dimension of the dimensional relationship is the angle for which the value of 15 degrees is defined.

The third data record relates to the ring 23. The third data record defines the circular lines 28, 29 as geometric elements. As geometric relationship(s), the third data record defines that the circular lines 28, 29 are concentric to each other and that, in addition, the diameter (or alternatively the radius) of the outer circular line 28 is 1.4 times the diameter (or radius) of the inner circular line 29. The dimension is therefore that of the diameter and therefore that of a length, with only the ratio of the lengths being defined in the third data record. Alternatively, values could be defined for both the outer circular line 28 and the inner circular line 29.

In the example embodiment, for example, the first data record is assigned the test feature “parallelism of the short straight lines 26, 27” and “straightness of the short straight lines 26, 27”, the second data record is also assigned this test feature of parallelism and straightness, to be precise both with respect to the long straight lines 24, 25 and with respect to the short straight lines 26, 27, and also the test feature of “inclination” or angling of the jaw vis-à-vis the grip area and the third data record is assigned the feature of the concentricity of the circular lines 28, 29 and the so-called two-point measure, in each case with respect to the individual circular lines 28, 29. The two-point measure is the deviation of two points, which are opposite each other in the direction of a line passing through the center of the circle, on the respective circular line 28, 29 from the diameter.

The three aforementioned data records in particular can be stored in a database, wherein a multiplicity of further data records are stored in the database in practice. If a workpiece as shown in FIG. 5 should now be measured, specifically a spanner 31 once again, the data records to which the spanner 31 to be measured corresponds can be ascertained on the basis of planning data of the spanner 31 to be measured or on the basis of the result of the measurement of the spanner 31.

In contrast to the spanner 21 shown in FIG. 3, the spanner 31 shown in FIG. 5 has a jaw 32, 34 at each end. Thus, the spanner 31 lacks the ring 23 at the right end of the spanner 21 from FIG. 3. Therefore, no positive determination result is obtained with respect to the third data record in the test regarding to which of the data records stored in the database the spanner from FIG. 5 corresponds, and the third data record is eliminated as a source for the test features assigned thereto. By contrast, both the first data record and the second data record can be identified as appropriate with respect to the jaws 32, 34 respectively. More concretely, it is therefore ascertained in the example embodiment described here that the short straight lines 26, 27 from FIG. 4 are present as geometric elements in each of the jaws 32, 34 and that the spacing of the short straight lines 26, 27 is equal to their length multiplied by 1.3. Therefore, each of the two jaws 30, 34 corresponds to the first data record. Further, with respect to each of the jaws 32, 34, both the long straight lines 24, 25 and the short straight lines 26, 27 are present as geometric elements, and, for each of the jaws 32, 34, one of the short straight lines 26, 27 makes an angle of 15 degrees with one of the long straight lines 24, 25. Therefore, each of the two jaws 30, 34 also corresponds to the second data record in relation to the grip area.

Thus, in the example embodiment, the aforementioned test features of “parallelism of the short straight lines 26, 27” and “straightness of the short straight lines 26, 27” (in relation to each of the two jaws 32, 34 to be precise) of the first data record, and the test features of “parallelism of the long straight lines 24, 25”, “straightness of the long straight lines 24, 25” and “inclination of the jaw vis-à-vis the grip area” of the second data record can be selected, in particular in order to incorporate them in a test plan of the spanner 31 to be measured or confirm them as test features of the test plan.

The above-described example embodiments can for example be extended as follows: For example, a data record defined with respect to spanner might still define additional geometries starting from the first data record (or at least one of these geometries might be defined in another data record), e.g. a circular arc adjacent to the two straight lines, which corresponds to the course of the closed end of the jaw. The points of intersection of the straight line with the circular arc assuming a predetermined position in the direction of the opening of the jaw can be defined as geometric relationship of the data record.

Finally, advantages and other aspects of the disclosure should be pointed out. Previously, some of a test plan for a workpiece to be measured was drawn up manually. In so doing, the designer/test technician was able to draw on their experience. The specification of test features depended significantly on their knowledge. In this context, a single person cannot be expected to have all the knowledge of previous tests of workpieces. In the present disclosure, this expert knowledge can be recorded systematically, stored centrally and used automatically for the identification of test features.

FIG. 6 schematically depicts a method for identifying an existing data record on the basis of geometric elements and a geometric relationship of the geometric elements. The method can be carried out automatically, for example, by a computer program that is executed on a computer or an arrangement of computers. After starting the method in step S1, one of a plurality of stored data records is selected in step S2. Optionally, the selection can be made on the basis of additional information. Alternatively, the additional steps can be carried out for each of the stored data records. This means that step S2 can be carried out repeatedly, in each case followed by steps S3 and S4.

In the following step S3, the geometric elements defined in the data record are searched for in the information and/or in available information regarding the workpiece. A set of geometric elements is available as the search space, the geometric elements being part of the aforementioned available information regarding the workpiece or being ascertained from this information. For example, the “cylinder” and “flat surface” geometric elements are available if a workpiece contains at least one cylindrical drilled hole in a cuboid block. In this case, the “cylinder” geometric element corresponds to the cylindrical drilled hole; the “flat surface” geometric element corresponds to the outer surfaces of the cuboid block in each case. It is therefore present multiple times in this example.

In the following step S4, the search space is restricted, i.e. elements of the specified set that do not correspond to the data record are eliminated. In this case, it is possible to both eliminate geometric elements that are not contained in the data record and eliminate geometric elements for which the geometric relationship of at least two geometric elements in relation to one another, as defined in the data record, is not satisfied. In an alternative or in addition to the elimination of elements, it is possible to identify elements (i.e. geometric elements) that correspond to the data record and, in particular, identify those elements for which the at least one geometric relationship of the at least two geometric elements in relation to one another, as defined in the data record, is satisfied.

In particular, by repeatedly carrying out step S4, it is either the case that so many geometric elements are eliminated from the set that there can no longer be a correspondence with the data record for the workpiece or the case that geometric elements, for which the at least one geometric relationship of at least two geometric elements to one another, as defined in the data record, also applies, remain and/or are identified. In particular, in the set of geometric elements, a plurality of groups of at least two geometric elements for which the at least one geometric relationship applies in each case can remain in each case. If at least one such group remains after reduction of the search space by at least one implementation of step S4 or by repeated implementation of step S4, then the data record was identified accordingly from the workpiece, and the at least one assigned test feature can be adopted in a test plan or be confirmed as belonging to the test plan.

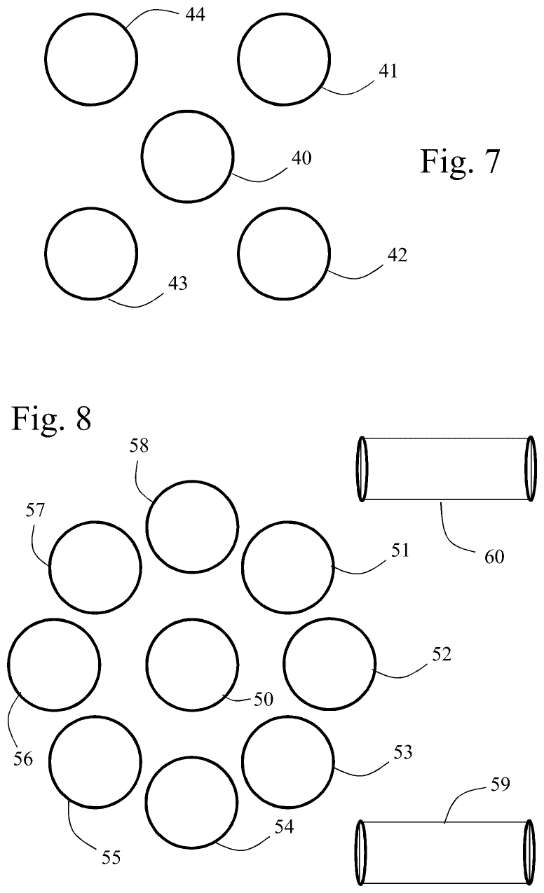

A specific example embodiment of steps S3 and S4 for an existing data record and a workpiece to be measured is now described on the basis of FIGS. 7 and 8. According to the existing data record (as shown in FIG. 7), five cylinders are present as geometric elements. Each of the cylinders 40 to 44 can be described by the radius of the depicted circular cross section and by its length (in a direction perpendicular to the figure plane of FIG. 7, for example defined by the length of the longitudinal axis). According to the existing data record, cylinders 40 to 44 have the same orientation in space, have the same position in space with respect to a labelled point (for example, the starting point of the longitudinal axis) in their longitudinal direction, have diameters or radii of equal size and have the same length in their longitudinal direction. In addition, the peripheral cylinders 41 to 44 have the same distance from the centrally located cylinder 40 and each have the same distance from their nearest adjacent cylinder in the periphery of the centrally located cylinder 40. For example, the distances of cylinders 41, 42 from one other and of cylinders 43, 44 from one another are therefore equal to each other. The data record is also assigned a test feature related to the positions of cylinders 40 to 44, the test feature relating to the distance between the cylinders. It also includes that the positions of cylinders 41 to 44 located in the periphery should not deviate from their target position by more than a specified maximum value (the value of which may be specified in the data record) of the position tolerance.

The workpiece to be measured, by contrast, has nine cylinders 50 to 58 aligned parallel to one another, as shown in FIG. 8. These nine cylinders 50 to 58 also have the same orientation in space, the same position in the direction of their longitudinal axes, the same diameter and the same length. Furthermore, the cylinders 51 to 58 located in the periphery each have the same distance from the cylinder 50 located in the central area and also the same distance from the peripheral cylinder closest thereto. In addition, two further cylinders 59, 60 are present, the longitudinal axes of which extend perpendicular to the longitudinal axes of the nine cylinders 50 to 58.

When step S3 is carried, out eleven “cylinder” geometric elements are therefore ascertained for the workpiece to be measured. When step S4 is carried out, the nine cylinders 50 to 58 are identified as corresponding to the existing data record. The tenth cylinder 59 and the eleventh cylinder 60 are excluded from the search space of the geometric elements since too few of the geometric relationships defined in the specified data record apply to these cylinders 59, 60. In particular, there is a lack of a central cylinder. In practice, the workpiece to be measured may contain additional geometric elements that either are identified as corresponding to another specified data record or are in each case removed for all specified data records from their search space of geometric elements.

In particular, two parts of the entire search space might be present when step S4 is carried out, either on an intermittent basis or until the completion of the implementation of step S4. In the example embodiment, the nine cylinders 50 to 58 are located in one part. In the example embodiment, the tenth cylinder 59 and the eleventh cylinder 60 are temporarily located in the other part. However, the cylinders 59, 60 are eliminated from this other part of the search space as soon as it is determined that indispensable geometric relationships defined in the specified data record do not apply thereto. The other part of the search space becomes empty as a result.

There can now be a modified definition of the existing data record, in which the above applies and, in addition, an absolute value of the distance between the cylinders 41 to 44 located in the periphery is defined or, alternatively, a ratio of the distances of the nearest adjacent cylinders 41 to 44 located in the periphery from each other to the distance of these cylinders 41 to 44 located in the periphery from the centrally located cylinder 40. In this case, the nine cylinders 50 to 58 of the workpiece to be measured would not satisfy all the geometric relationships of the geometric elements to one another defined in the data record, specifically not the specified additionally defined feature. However, a selection of the nine cylinders 50 to 58 would also correspond to this existing data record, i.e. satisfy all defined geometric relationships. This selection relates to cylinders 50, 51, 53, 55 and 57. Should the search algorithm or identification algorithm for implementing step S4 be configured accordingly, this selection of cylinders 50, 51, 53, 55 and 57 could therefore also be identified as corresponding to the existing data record. For this purpose, the algorithm could for example include a step in which an additional cylinder is searched for in relation to a first cylinder, e.g. cylinder 53, located in the periphery, this additional cylinder being located in the periphery of the central cylinder 50 and being at the distance specified by the data record from the first cylinder located in the periphery. In relation to cylinder 53, this is true for cylinders 51 and 55. The procedure would have to be followed accordingly for additional cylinders in the periphery. It should be observed that the modified definition of the existing data record is satisfied not only by the aforementioned selection of five cylinders, but also by the selection of the five cylinders 50, 52, 54, 56, 58. Therefore, in step S4, these two selections or groups of five cylinders in each case are identified.

Optionally, in step S4 or in another configuration of the method, an incomplete correspondence with the existing data record can also be determined if the geometric elements of the workpiece to be measured do not satisfy all the geometric relationships to one another, which are defined in the data record. With respect to the previous example with the modified definition of the existing data record, for example, the test result that there is a broad correspondence with the geometric relationships defined in the data record but the absolute value of the spacing of the cylinders 41 to 44 located in the periphery does not correspond to the data record can be output also with respect to the nine cylinders 50 to 58. The aforementioned assigned test feature of the distance with a certain position tolerance can also be used advantageously in this case.

This is an example of the fact that even if a workpiece deviates from the definition in the existing data record, the at least one assigned test feature can be incorporated in the test plan, or this test feature can be confirmed in the test plan. Optionally, geometric relationships can be labelled in the existing data record, for example as non-essential if all other geometric relationships are satisfied or alternatively be labelled as essential. If an essential geometric relationship is not satisfied, then no correspondence with the existing data record is determined as well.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A method of using at least one coordinate measuring machine to measure a designated workpiece, the method comprising:
accessing a database in which a plurality of data records are stored, each data record including data on:
at least two geometric elements that a workpiece might contain,
at least one geometric relationship of the at least two geometric elements in relation to one another, wherein the geometric relationship is a dimensional relationship allowing determination as to whether the geometric relationship exists in a workpiece to be measured, by way of ascertaining and evaluating coordinates of the at least two geometric elements, and
a test feature assigned to the at least two geometric elements, wherein the assigned test feature is testable with respect to the at least two geometric elements for a workpiece to be tested;
ascertaining workpiece coordinates for the designated workpiece by at least one of evaluating measurement data of the designated workpiece or planning data of the designated workpiece;
creating a determination result by determining, based on the workpiece coordinates, whether the designated workpiece contains the at least two geometric elements and the at least one geometric relationship of at least one of the plurality of data records; and
generating a test plan for measuring at least one of the designated workpiece or a second workpiece having a same type as the designated workpiece, wherein the generating includes, depending on the determination result in relation to the respective data record, at least one of incorporating the assigned test feature in the test plan or confirming presence of the assigned test feature in the test plan.

2. The method of claim 1 wherein:
at least one of the data records in the database includes, besides the data on the assigned test feature, additional information concerning implementation of the measurement of the workpiece or a reference regarding the additional information, and
depending on the determination result, the additional information is incorporated in the test plan and/or a measurement plan, corresponding to the test plan, for measuring the designated workpiece or for measuring a workpiece of the same type and/or is confirmed as part of the test plan.

3. The method of claim 1 wherein, when determining whether the designated workpiece contains the at least two geometric elements and the at least one geometric relationship of at least one of the plurality of data records:
there is an initial determination with respect to one of the data records as to whether the designated workpiece contains all the geometric elements for which the geometric relationship of the geometric elements is defined in relation to one another in the data record, and
if so, there is a subsequent determination as to whether the geometric relationship exists for the geometric elements of the designated workpiece.

4. The method of claim 1 wherein:
there is an ascertainment of a plurality of the data records stored in the database, which each:
define data record geometric elements corresponding to the same plurality of geometric elements of the designated workpiece, and
define the geometric relationship for these data record geometric elements,
a measure for a correspondence of the geometric elements and the geometric relationship is ascertained for each of the plurality of ascertained data records, and
the measure of correspondence is used to ascertain at least one of the plurality of ascertained data records as non-corresponding or having a lower correspondence than at least one other data record of the plurality of determined data records.

5. The method of claim 1 further comprising measuring the designated workpiece by at least one coordinate measuring machine, wherein the measurement data are created to ascertain the workpiece coordinates.

6. The method of claim 1 further comprising measuring the designated workpiece or the second workpiece by the at least one coordinate measuring machine according to the test plan.

7. The method of claim 1 further comprising ascertaining a value of the test feature by the at least one coordinate measuring machine.

8. A non-transitory computer-readable storage medium comprising instructions including:
accessing a database in which a plurality of data records are stored, each data record including data on:
at least two geometric elements that a workpiece might contain,
at least one geometric relationship of the at least two geometric elements in relation to one another, wherein the geometric relationship is a dimensional relationship allowing determination as to whether the geometric relationship exists in a workpiece to be measured, by way of ascertaining and evaluating coordinates of the at least two geometric elements, and
a test feature assigned to the at least two geometric elements, wherein the assigned test feature is testable with respect to the at least two geometric elements for a workpiece to be tested;
ascertaining workpiece coordinates for a designated workpiece by at least one of evaluating measurement data of the designated workpiece or planning data of the designated workpiece;
creating a determination result by determining, based on the workpiece coordinates, whether the designated workpiece contains the at least two geometric elements and the at least one geometric relationship of at least one of the plurality of data records; and
generating a test plan for measuring at least one of the designated workpiece or a second workpiece having a same type as the designated workpiece, wherein the generating includes, depending on the determination result in relation to the respective data record, at least one of incorporating the assigned test feature in the test plan or confirming presence of the assigned test feature in the test plan.

9. An apparatus comprising:
an access device configured to access a database in which a plurality of data records are stored, each containing data on:
at least two geometric elements that a workpiece might contain,
at least one geometric relationship of the at least two geometric elements in relation to one another, wherein the geometric relationship is a dimensional relationship allowing determination as to whether the geometric relationship exists in a workpiece to be measured, by way of ascertaining and evaluating coordinates of the at least two geometric elements, and
a test feature assigned to the at least two geometric elements, wherein the assigned test feature is testable with respect to the at least two geometric elements for a workpiece to be tested;
an evaluation device configured to ascertain workpiece coordinates, for a designated workpiece, by evaluating at least one of measurement data of the designated workpiece or planning data of the designated workpiece;
a determination device configured to use the workpiece coordinates to determine whether the designated workpiece contains the at least two geometric elements and the at least one geometric relationship of at least one of the plurality of data records, and to create a corresponding determination result; and
a test plan device configured to, depending on the determination result in relation to the respective data record, at least one of (i) incorporate the assigned test feature in a test plan for measuring the designated workpiece or a second workpiece of a same type as the designated workpiece or (ii) confirm the assigned test feature as part of the test plan.

10. A system comprising:
the apparatus of claim 9; and
at least one coordinate measuring machine configured to carry out measurement of at least one of the designated workpiece or the second workpiece and create corresponding measurement data.

11. A system comprising:
the apparatus of claim 9; and
the database.
